(19) United States
(12) Patent Application Publication
(10) Pub. No.: US 2011/0074128 A1
(43) Pub. Date: Mar. 31, 2011

(54) ELASTOMERIC GRIP TAPE

(76) Inventor: Jonathan CHANG, San Jose, CA (US)

(21) Appl. No.: 12/890,458

(22) Filed: Sep. 24, 2010

Related U.S. Application Data
(60) Provisional application No. 61/277,451, filed on Sep. 25, 2009.

(51) Int. Cl. A63C 17/00; C09J 7/02; B32B 3/30; B32B 27/00; B32B 3/10

(52) U.S. Cl. 280/87.042; 428/41.8; 428/141; 428/172

(57) ABSTRACT

Elastomeric grip tapes are presented including: an elastomeric layer, where the elastomeric layer is a low-abrasion layer having a hardness in a range of approximately 30 to 95 Shore A, and where the elastomeric layer includes a top surface formed having a texture with a peak-valley depth in a range of approximately 0.000 to 0.500 inches; and a pressure sensitive adhesive layer formed along a bottom surface of the elastomeric layer. In some embodiments, elastomeric grip tapes further include: a release/carrier layer removably adhered with the pressure sensitive adhesive layer for temporarily protecting the pressure sensitive adhesive layer. In some embodiments, elastomeric grip tapes further include: a plurality of perforations defining a shape which shape may be adhered to a surface.

### PRIORITY CLAIM TO PROVISIONAL APPLICATION

A claim for priority is hereby made under the provisions of 35 U.S.C. §119 for the present application based upon U.S. Provisional Application No. 61/227,451, filed on Sep. 25, 2009, which is incorporated herein by reference.

### BACKGROUND

Embodiments of the present invention relate to low abrasion, non-skid surface tapes.

Many conventional grip tape solutions have focused generally on providing an abrasive surface that provides additional traction to an otherwise slippery surface such, for example, abrasive strips located on stair treads. Abrasive grip tape is generally well-known in the prior art. There have been several disclosed flexible sheets with non-skid surfaces and adhesive backing to be adhered to an underlying surface. Exemplary of such structures include: U.S. Pat. No. 6,921,566; U.S. Pat. No. 5,622,759; U.S. Pat. No. 3,578,550; and U.S. Pat. No. 3,227,604. However these structures rely on the engineering effect of abrasion in order to provide a non-skid surface, and none have been designed to provide adequate frictional characteristics while limiting the damaging effect of abrasiveness or offering a new, low-abrasive method of providing a non-skid surface. Though these innovations are useful and may serve a specific purpose, they are not suitable for the purposes of some embodiments of the present invention.

For example, when skateboards and abrasive grip tape first emerged, the sport mainly consisted of flat land tricks that involved turning and carving. Modern skateboarding has evolved in the last 20 years with the addition of double kicktails and other aerial tricks, which require a user to create frictional forces by sliding their foot across the board's surface or kicktails. Abrasive grip tapes utilized in skateboarding conventionally provides at least two important functions. The first function is to provide a non-skid surface so a user does not slip off while maneuvering the board. The second function relates to performance of tricks, wherein a user slides his/her shoe across the surface of the skateboard in order to create a frictional force, which manipulates the board into rotating, flipping or sticking to the user's feet in midair etc. To provide this frictional surface, abrasive grip tape of the prior art typically consists of laminated particles of silicon carbide, aluminum oxide or abrasive granules and the like to a flexible sheet material and utilizes the engineering effect of abrasion to create said frictional surface. In particular, silicon carbide and abrasive granules of the like are hard materials typically used for industrial grinding or cutting processes. However, when a user slides their shoe across the abrasive frictional surface of current grip tape of the prior art, extensive damage and accelerated wear and tear of the user's shoe may result. This sliding action may be likened to literally rubbing a shoe against sandpaper for several hours a day. Therefore the evolution of modern skateboarding and method for performing tricks has made abrasive grip tape of the prior art a big problem affecting shoe durability and accelerating its wear. Thus, although the prior art is feasible and useful for providing a frictional surface, it is not especially suitable for modern skateboarding.

It may be appreciated that many conventional abrasive grip tape applications suffer from similar problems as skateboarding where unwanted abrasion damage occurs. As such, elastomeric grip tapes are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, elastomeric grip tapes are presented including: an elastomeric layer, where the elastomeric layer is a low-abrasion layer having a hardness in a range of approximately 30 to 95 Shore A, and where the elastomeric layer includes a top surface formed having a texture with a peak-valley depth in a range of approximately 0.000 to 0.500 inches; and a pressure sensitive adhesive layer formed along a bottom surface of the elastomeric layer. In some embodiments, the elastomeric layer is manufactured from an elastomeric compound such as: natural rubber, ethylene vinyl acetate (EVA), ethylene propylene diene monomer (EPDM), styrene-butadiene rubber (SBR), nitrile rubber (NBR), thermoplastic elastomers/thermoplastic vulcanizates (TPE/TPV), thermoplastic elastomer polyolefin (TPO), silicone rubber (SI,Q,VMQ), polyacrylic rubber, fluoroelastomers (FKM, FPM), Flurosilicone rubber (FVMQ), Tetrafluoro ethylene/propylene rubbers (FEPM), Chlorosulfonated Polyethylene (CSM), Ethylene propylene rubber (EPM), Polyisoprene (IR), Polybutadiene (BR), Polyurethane rubber, and elastomer-based foams. In some embodiments, the pressure sensitive adhesive layer includes: an acrylic compound, a methacrylate compound, a rubber compound, a water based compound, a solvent based compound, a silicone compound and a styrene compound. In some embodiments, elastomeric grip tapes further include: a release/carrier layer removably adhered with the pressure sensitive adhesive layer for temporarily protecting the pressure sensitive adhesive layer. In some embodiments, the hardness is approximately 55 shore A. In some embodiments, the texture includes: a random texture, a patterned texture, a smooth texture, and a heavy matte surface. In some embodiments, the peak-valley depth is approximately 0.012 inches. In some embodiments, the elastomeric layer provides a static or a kinetic coefficient of friction in a range of approximately 0.20 to 15.00 COF. In some embodiments, the elastomeric layer has a thickness in a range of approximately 0.010 to 0.500 inches. In some embodiments, elastomeric grip tapes further include: a plurality of perforations defining a shape which shape may be adhered to a surface. In some embodiments, the shape is the shape of skateboard.

In other embodiments, skateboards having a low-abrasion frictional surface are presented including: a base having a top surface; an elastomeric layer adhered with the top surface of the base, where the elastomeric layer is a low-abrasion layer having a hardness in a range of approximately 30 to 95 Shore A, and where the elastomeric layer includes a top surface formed having a texture with a peak-valley depth in a range of approximately 0.000 to 0.500 inches; and a pressure sensitive adhesive layer formed along a bottom surface of the elastomeric layer.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a cross-sectional view of a portion of an elastomeric grip tape in accordance with embodiments of the present invention;

FIG. 2 is an illustrative representation of a cross-sectional view of a portion of an elastomeric grip tape applied to a surface in accordance with embodiments of the present invention; and

FIG. 3 is an illustrative representation of an elastomeric grip tape as applied to a skateboard in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As utilized herein, the term elastomeric is substantially synonymous with and includes a broad class of compounds of elastomers and elastomer mixes which elastomer mixes may include without limitation, plastic only blends, thermoplastics, and vulcanates without limitation and without departing from embodiments disclosed herein.

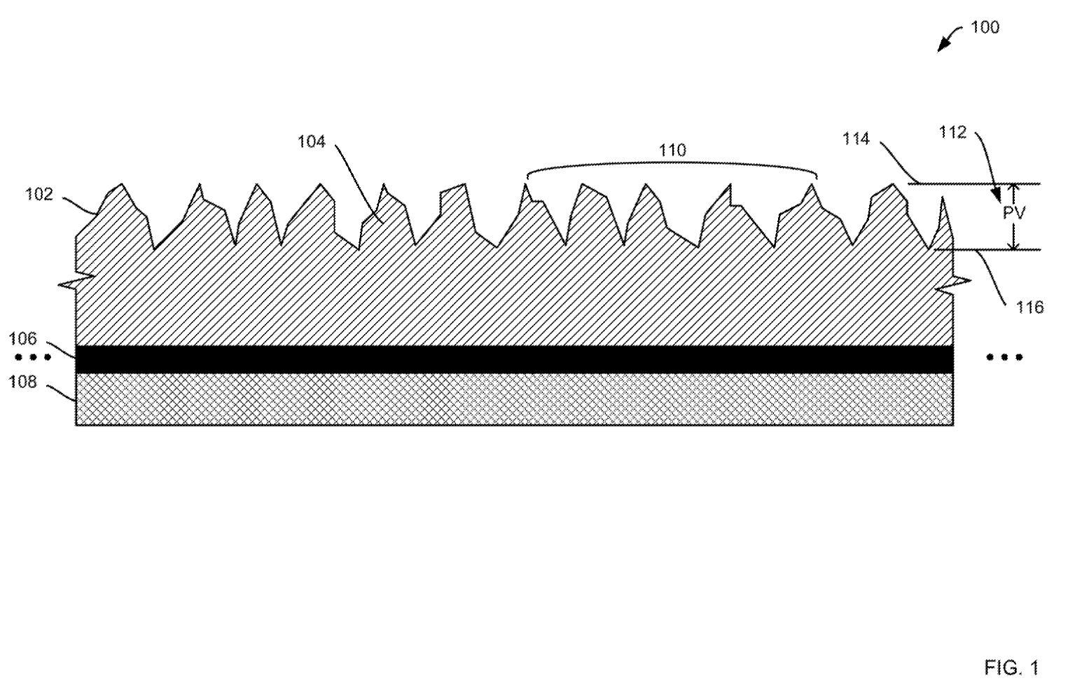

FIG. 1 is an illustrative representation of a cross-sectional view 100 of a portion of an elastomeric grip tape in accordance with embodiments of the present invention. In particular, the illustrated portion represents an embodiment prior to application to a surface. As illustrated elastomeric layer 104 may provide a low abrasion frictional surface to another surface. In embodiments, surfaces may be rigid or flexible without limitation. In addition, surfaces may be planar or non-planar without limitation. Conformance with non-planar surfaces is possible because of the elasticity of compounds utilized in embodiments provided herein. As such, elastomeric layers may be manufactured from any number of elastomeric compounds including without limitation: natural rubber, ethylene vinyl acetate (EVA), ethylene propylene diene monomer (EPDM), styrene-butadiene rubber (SBR), nitrile rubber (NBR), thermoplastic elastomers/thermoplastic vulcanizates (TPE/TPV), thermoplastic elastomer polyolefin (TPO), silicone rubber (SI,Q,VMQ), polyacrylic rubber, fluoroelastomers (FKM, FPM), Flurosilicone rubber (FVMQ), Tetrafluoro ethylene/propylene rubbers (FEPM), Chlorosulfonated Polyethylene (CSM), Ethylene propylene rubber (EPM), Polyisoprene (IR), Polybutadiene (BR), Polyurethane rubber, and elastomer-based foams. In embodiments, elastomeric layers may have a thickness in a range of approximately 0.010 to 0.500 inches, more preferably 0.030 inches.

As noted above, in some conventional solutions, highly abrasive materials may be utilized to create a highly frictional surface. While highly abrasive materials may provide a highly frictional surface, they can, in some examples cause undue wear with surfaces that come into contact with them. In some examples, such as when skin is in direct contact with the highly abrasive materials, contact abrasion may result causing, in some examples, severe discomfort. In other examples, contact between surfaces can cause excessive wear, which may increase indirect costs associated with the use of highly abrasive materials. Thus, low abrasion elastomeric layers may be advantageous in some applications. As such, in embodiments, elastomeric layers may be provided having a hardness in a range of 30 to 95 Shore A, more preferably 55 Shore A. By utilizing an elastomeric hardness that is lower than, equal to, or somewhat higher than a hardness of an expected surface, abrasion may be reduced or avoided altogether.

In order to compensate for absence of abrasive materials that provide friction, some embodiments employ a texture on surface 102. For example, a peak-valley depth is the measure of the difference between the highest 114 and lowest points 116 of the textured top surface. A preferred peak-valley depth may be further determined using engineering analysis of the ideal ratio between coefficient of friction and the textured peak-valley depth of the embodiment. Also, the preferred overall thickness of the sheet material may be further determined using engineering analysis and experimentation between overall thickness and its effect on coefficient of friction. In embodiments, without being bound by theory, elastomeric layers may have a peak valley depth in a range of approximately 0.000 to 0.500 inches, more preferably 0.012 inches. In embodiments, having a 0.000 peak valley depth range, the surface is substantially smooth. As illustrated, surface 112 has a random texture 110. However, in other embodiments, textures may include a patterned texture, a smooth texture, and a heavy matte surface. It may be appreciated that in some embodiments, textured surfaces may be produced during an extrusion process utilizing a textured roller. However, textures may be produced in any manner known in the art without departing from the present invention. As such, by configuration of an appropriate hardness coupled with an appropriate texture, in embodiments, elastomeric layers may be configured to provide a static or a kinetic coefficient of friction in a range of approximately 0.20 to 15.00 COF.

Friction can be described as an electromagnetic force between charged particles, which must be calculated through experimentation or empirically. Until recently, the scientific world believed friction was a direct effect of surface roughness; however this does not represent the complete story. On a typical size scale, such as a skateboard, kinetic friction is caused by chemical bonding of two surfaces known as molecular adhesion. In particular, molecular adhesion is when two surfaces intimately contact, and their atoms or molecules attract each other by electromagnetic forces; these forces will from hereafter be referred to as adhesion. Therefore the frictional forces acting on an object are in essence the forces required to break these adhesive bonds. In addition, material composition may also affect adhesion if the material is sticky such as rubber.

Physically, friction work can be described as translating into abrasion/wear, deformation, or heat. As noted above, abrasive grip tapes of the prior art are designed to create friction primarily through abrasion or displacement of material. In particular, conventional abrasive methods provide a frictional surface utilizing one hard material with high surface roughness or asperities to physically interfere with a softer material where particles of the softer material become dislodged from their surface. In this case, surface roughness and differences in hardness are the major contributing factors creating friction with some help from adhesion.

Conversely, embodiments of the present invention are designed to be similar in hardness to a user's shoe and to utilize the effects of deformation and exothermic/heat reaction from adhesion instead of wear or displacement of material from abrasion. In particular, softer materials may deform under pressure, therefore an object moving across this surface must overcome this deformation and further increases resistive forces of friction. In addition, certain materials provide better adhesion coupled with a sticky effect, which may translate to heat when these bonds are broken. Therefore, embodiments of the present invention may be able to achieve similar frictional properties and advantages over abrasive grip tape of the prior art by utilizing deformation and heat transfer identified through analysis from engineering experimentation as well as from the empirical study of effects of adhesion between different materials without one surface abrading another.

As further illustrated, elastomeric grip tape embodiments include pressure sensitive adhesive layer (PSA) 106 formed along the bottom surface of elastomeric layer 104. PSA layers may be configured to bond to elastomeric layers and to target surfaces so that a secure gripping surface may be achieved. As such, PSA layers may include a number of adhesive properties which provide for bonding with different materials. In embodiments, PSA layer may include an acrylic compound, a methacrylate compound, a rubber compound, a water based compound, a solvent based compound, a silicone compound and a styrene compound. As may be appreciated, in embodiments, adhesives may provide a conformal adhesion equally well with non-planar surfaces as well as planar surfaces. In some embodiments, a release/carrier layer 108 may be removably adhered/coated with PSA layer 106 for convenience in packaging and handling for example. Release layers may be easily removed when bonding to a surface is required.

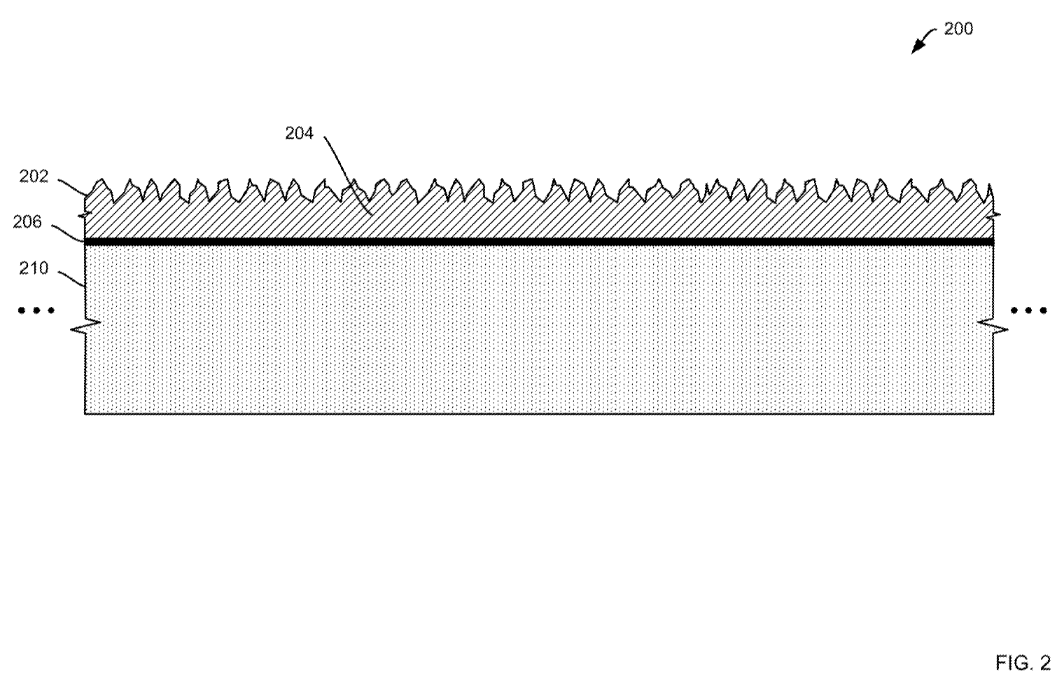

FIG. 2 is an illustrative representation of a cross-sectional view 200 of a portion of an elastomeric grip tape 204 applied to a surface 210 in accordance with embodiments of the present invention. In particular, elastomeric layer 204 having a randomly textured surface 202 is bonded with a planar surface 210. Elastomeric layer 204 may be bonded with planar surface 210 by PSA layer 206. In some embodiments, planar surfaces include a skateboard. It should be noted that illustrations presented herein are provided for clarity in understanding embodiments disclosed herein and should not be construed as limiting with respect to any dimension such as thickness.

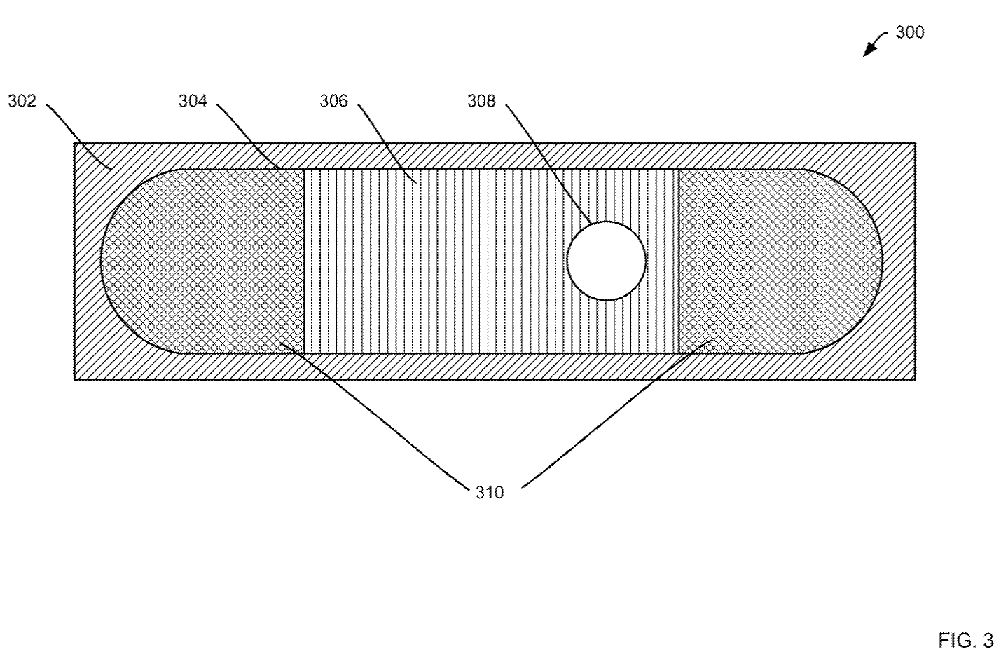

FIG. 3 is an illustrative representation 300 of an elastomeric grip tape 302 as applied to a skateboard in accordance with embodiments of the present invention. In particular, FIG. 3 represents an embodiment having a skateboard cut-out 304. Skateboard cut-outs may be utilized to provide pre-determined shapes—in this case, a skateboard. In other embodiments, cut-outs may define any shape. For example, in one embodiment, round buttons may be defined which may be peeled from release liner and applied to any number of surfaces. Cut-outs may include perforations or pre-cuts, which perforations or pre-cuts may be through cut or partial cut in embodiments. In a skateboard embodiment, different elastomeric grip tape formulations may be utilized for different locations. That is, elastomeric grip tape top surface may vary in texture, material, hardness or the like to provide advantages including but not limited to more/less friction, aesthetics or durability in specific locations. For example, nose and tail texture 310 may provide added friction over center texture 306. In addition, in embodiments, a window of pre-determined size 308 may be perforated, laser cut, or die cut to showcase graphics on an applied surface such as a skateboard. In some embodiments, cut may be configured to allow through hole access such as for bolts/screws. In still other embodiments, window 308 may be manufactured utilizing elastomeric embodiments that are clear such that traction may be maintained over graphics. It may be appreciated that any size or shape may be utilized for window 308 without departing from embodiments provided herein.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. An elastomeric grip tape including:
an elastomeric layer, wherein
the elastomeric layer is a low-abrasion layer having a hardness in a range of approximately 30 to 95 Shore A, and wherein
the elastomeric layer includes a top surface formed having a texture with a peak-valley depth in a range of approximately 0.000 to 0.500 inches; and
a pressure sensitive adhesive (PSA) layer formed along a bottom surface of the elastomeric layer.

2. The elastomeric grip tape of claim 1, wherein the elastomeric-layer is manufactured from an elastomeric compound selected from the group consisting of: natural rubber, ethylene vinyl acetate (EVA), ethylene propylene diene monomer (EPDM), styrene-butadiene rubber (SBR), nitrite rubber (NBR), thermoplastic elastomers/thermoplastic vulcanizates (TPE/TPV), thermoplastic elastomer polyolefin (TPO), silicone rubber (SI,Q,VMQ), polyacrylic rubber, fluoroelastomers (FKM, FPM), Flurosilicone rubber (FVMQ), Tetrafluoro ethylene/propylene rubbers (FEPM), Chlorosulfonated Polyethylene (CSM), Ethylene propylene rubber (EPM), Polyisoprene (IR), Polybutadiene (BR), Polyurethane rubber, and elastomer-based foams.

3. The elastomeric grip tape of claim 1, wherein the PSA layer is selected from the group consisting of: an acrylic compound, a methacrylate compound, a rubber compound, a water based compound, a solvent based compound, a silicone compound and a styrene compound.

4. The elastomeric grip tape of claim 1, further including:
a release/carrier layer removably adhered with the PSA layer for temporarily protecting the PSA layer.

5. The elastomeric grip tape of claim 1, wherein the hardness is approximately 55 shore A.

6. The elastomeric grip tape of claim 1, wherein the texture is selected from the group consisting of: a random texture, a patterned texture, a smooth texture, and a heavy matte surface.

7. The elastomeric grip tape of claim 1, wherein the peak-valley depth is approximately 0.012 inches.

8. The elastomeric grip tape of claim 1, wherein the elastomeric layer provides a static or a kinetic coefficient of friction in a range of approximately 0.20 to 15.00 COF.

9. The elastomeric grip tape of claim 1, wherein the elastomeric layer has a thickness in a range of approximately 0.010 to 0.500 inches.

10. The elastomeric grip tape of claim 9, wherein the elastomeric layer has a thickness of approximately 0.030 inches.

11. The elastomeric grip tape of claim 4, further including:
a plurality of perforations defining a shape which shape may be adhered to a surface.

12. The elastomeric grip tape of claim 11, wherein the shape is the shape of skateboard.

13. A skateboard having a low-abrasion frictional surface including:
a base having a top surface;
an elastomeric layer adhered with the top surface of the base, wherein
the elastomeric layer is a low-abrasion layer having a hardness in a range of approximately 30 to 95 Shore A, and wherein
the elastomeric layer includes a top surface formed having a texture with a peak-valley depth in a range of approximately 0.000 to 0.500 inches; and
a PSA layer formed along a bottom surface of the elastomeric layer.

14. The skateboard of claim 13, wherein the elastomeric layer is manufactured from an elastomeric compound selected from the group consisting of: natural rubber, ethylene vinyl acetate (EVA), ethylene propylene diene monomer (EPDM), styrene-butadiene rubber (SBR), nitrile rubber (NBR), thermoplastic elastomers/thermoplastic vulcanizates (TPE/TPV), thermoplastic elastomer polyolefin (TPO), silicone rubber (SI,Q,VMQ), polyacrylic rubber, fluoroelastomers (FKM, FPM), Flurosilicone rubber (FVMQ), Tetrafluoro ethylene/propylene rubbers (FEPM), Chlorosulfonated Polyethylene (CSM), Ethylene propylene rubber (EPM), Polyisoprene (IR), Polybutadiene (BR), Polyurethane rubber, and elastomer-based foams.

15. The skateboard of claim 13, wherein the hardness is approximately 55 shore A.

16. The skateboard of claim 13, wherein the texture is selected from the group consisting of: a random texture, a patterned texture, a smooth texture, and a heavy matte surface.

17. The elastomeric grip tape of claim 13, wherein the peak-valley depth of approximately 0.012 inches.

18. The elastomeric grip tape of claim 13, wherein the elastomeric layer provides a static or a kinetic coefficient of friction in a range of approximately 0.20 to 15.00 COF.

19. The elastomeric grip tape of claim 13, wherein the elastomeric layer has a thickness in a range of approximately 0.010 to 0.500 inches.

20. The elastomeric grip tape of claim 19, wherein the elastomeric layer has a thickness of approximately 0.030 inches.
